(19) United States
(12) Patent Application Publication
(10) Pub. No.: US 2024/0102180 A1
(43) Pub. Date: Mar. 28, 2024

(54) METHOD FOR OPERATING AN ELECTROLYSIS SYSTEM AND ELECTROLYSIS SYSTEM

(71) Applicant: Linde GmbH, Pullach (DE)

(72) Inventors: Andreas WOLF, Pullach (DE); Anton WELLENHOFER, Pullach (DE); Marius DILLIG, Pullach (DE); Ole MÜLLER-THORWART, Pullach (DE); Robert BIRK, Pullach (DE)

(21) Appl. No.: 18/472,842

(22) Filed: Sep. 22, 2023

(30) Foreign Application Priority Data
Sep. 28, 2022 (EP) 22020462.2

(51) Int. Cl. C25B 1/04; C25B 15/08

(52) U.S. Cl. CPC C25B 1/04; C25B 15/083

(57) ABSTRACT

The invention relates to a method for operating an electrolysis system in which water is converted into oxygen and hydrogen in an electrolysis unit, wherein a fluid flow including water and gas is conducted from an oxygen side of the electrolysis unit to a gas separator, wherein an ignition of an ignition device is actively produced in the fluid flow. The invention also relates to a corresponding electrolysis system.

### CROSS-REFERENCE TO RELATED APPLICATIONS

This application claims priority pursuant to 35 U.S.C. 119(a) to European Application No. 22020462.2, filed Sep. 28, 2022, which application is incorporated herein by reference in its entirety.

### FIELD

The invention relates to a method for operating an electrolysis system for water electrolysis, and to such an electrolysis system, which is used, for example, to obtain hydrogen.

### PRIOR ART

To obtain hydrogen, so-called electrolysis can be used, in which, for example, water is split or converted into oxygen and hydrogen by means of electrical energy. This is also referred to as water electrolysis. So-called proton exchange membrane electrolysis (PEM electrolysis) is a possibility here, for example.

A large part of the water usually remains on the oxygen side of the membrane during PEM electrolysis. While the hydrogen is produced and discharged on the other side of the membrane, the oxygen initially remains in the water and is then typically separated from the water in a container.

However, it is possible that some hydrogen is also produced on the oxygen side or diffuses back there, or gets there in some other way, e.g., due to defects or cracks in the membrane. An explosive mixture can result which, under certain circumstances, can ignite somewhere and can damage the electrolysis system due to the resulting explosion. Against this background, the object arises of making an electrolysis system or its operation safer.

### DISCLOSURE OF THE INVENTION

This object is achieved by a method for operating an electrolysis system and an electrolysis system having the features of the independent claims. Embodiments are the subject matter of the dependent claims and the following description.

### Advantages of the Invention

The invention is concerned with water electrolysis and electrolysis systems or their operation for this purpose. Such electrolysis systems typically serve to produce or obtain hydrogen by means of electrolysis. In so-called water electrolysis, water is converted (split) into hydrogen and oxygen; i.e., in addition to hydrogen, oxygen is also always obtained or produced at the same time. In water electrolysis, for example, there is so-called alkaline water electrolysis (AEL, “alkaline electrolysis”) or so-called proton exchange membrane electrolysis (PEM electrolysis, “proton exchange membrane” electrolysis). The fundamental principles of these are known, e.g., from “Bessarabov et al: PEM electrolysis for Hydrogen production. CRC Press.”

In addition, there are also so-called solid oxide electrolyzer cells (SOEC, “solid oxide electrolysis cell”) and anion exchange membrane electrolysis (AEM electrolysis, “anion exchange membrane” electrolysis). In particular, those electrolysis technologies that occur at low temperatures, e.g., PEM, AEL, and AEM electrolysis, are suitable for supporting the transition of power generation to renewable energy because of their potential for flexible operation.

In PEM electrolysis, for example, water, and in particular demineralized water, is fed as feed medium to an electrolysis unit with a proton exchange membrane (PEM), in which the feed medium, i.e., the water, is converted (split) into hydrogen and oxygen.

As mentioned, a large part of the water usually remains on the oxygen side of the membrane in PEM electrolysis. While the hydrogen is produced and discharged on the other side of the membrane, the oxygen initially remains in the water and is then typically separated from the water in a container (used as a gas or oxygen separator).

However, it is possible that some hydrogen is also produced on the oxygen side or diffuses back there, or gets there in some other way, e.g., due to defects or cracks in the membrane. The fluid flow to be discharged from the oxygen side thus contains not only water and oxygen, but possibly also hydrogen, i.e., water and gas in general; the term gas is generally understood here to mean gaseous medium, not only a single gas, but also a gas mixture that may be present. An explosive mixture can thus arise on the oxygen side of the electrolysis unit or in the fluid flow, which mixture can, under certain circumstances, ignite somewhere in the electrolysis system downstream of the electrolysis unit, whether in the fluid flow to the oxygen or gas separator or subsequently in the gas flow separated and discharged there (not only the oxygen but also any hydrogen present is then separated). The resulting explosion or detonation can damage the electrolysis system.

Ignition of the mixture can occur in particular if the proportion of hydrogen in the gas (the proportion of water is not relevant here) exceeds a certain predefined proportion, the so-called lower explosive limit (LEL); this is typically around 4%, for example, during standby operation or operation of the electrolysis system with a low load. The (lower) explosion limit of a gas indicates the content in a gas mixture above which ignition or explosion is possible with sufficient oxygen content at the same time.

Since an ignition source in the electrolysis unit or somewhere downstream cannot usually be excluded or avoided, a potential ignition or explosion or detonation must always be taken into account when operating an electrolysis system. An explosion is an uncontrolled burning off of an ignitable gas mixture with a laminar flame front. An explosion differs from a detonation essentially in the speed of propagation.

The reaction between hydrogen and oxygen proceeds very quickly and generates very high flame velocities, i.e., high velocities at which the flames propagate, for example in corresponding fluid connections or fluid lines. In the case of an explosion, this is below the speed of sound; in the case of a detonation, it is typically well above the speed of sound. Explosions and detonations of gases or gas mixtures cause a massive increase in pressure. Typically, a pressure increase by a factor of ten can be expected in the event of an explosion. The effects of a detonation are significantly more serious. Here the pressure increase factor can be 25 or even 50 and more. An explosion can turn into a detonation after a certain start-up length and a minimum concentration of fuel and oxygen. Thus, pressures may arise which are in part 25 times or even 50 times the actual operating pressure in the electrolysis system, in particular downstream of the oxygen side and the flow, and possibly also upstream.

Thus, to avoid any damage to the electrolysis system, the relevant fluid or gas lines can be designed for correspondingly high pressures. Depending on the electrolysis system and the use of the oxygen, very many or long lines can be affected here. This applies not only to the fluid lines from the electrolysis unit to the gas separator, but also to any gas lines in which the separated oxygen (and possibly hydrogen) is routed to one or more desired uses or other processing steps. This can result in particularly high costs.

Against this background, it is now proposed, in an electrolysis system as described above, to actively produce (or cause) an ignition in the fluid flow from the oxygen side of the electrolysis unit to the gas separator (or the container used as gas separator) by providing a suitable ignition device. In this way, any hydrogen present or any ignitable gas or gas mixture is ignited in a controlled manner at a desired location. An uncontrolled ignition at any point is thus prevented, since no ignitable gas or gas mixture can be present downstream of the active ignition. Accordingly, it is also expedient if the ignition is performed as close as possible to or immediately after the electrolysis unit. It should be mentioned that although an ignition of the ignition device or in the ignition device takes place, the gas or gas mixture is not usually ignited, but only in cases or exceptional situations in which, for example, the concentration of hydrogen is too high.

The ignition is preferably produced at regular or irregular time intervals, in particular with a predetermined frequency, having for example a value between 5 Hz and 50 Hz. It is thus achieved that only a little new hydrogen is present in the fluid flow and reacts during the ignition, so that the extent of the explosion is kept small.

It is also preferred if it is monitored whether the ignition is being produced, and in particular if it is detected that the ignition is not produced—i.e., has not been produced due to an error, for example, even though it was actually triggered—an error reaction is initiated, e.g., an error message is output or the electrolysis system is switched off. For this purpose, for example an optical monitoring can be provided in the ignition device in order to detect whether an ignition spark has been produced. Likewise, e.g., a voltage or current monitor can be provided that detects whether the ignition spark has been produced. This allows the ignition of the ignition device to be monitored regardless of whether the gas or gas mixture has also been ignited in the process.

Since high pressures can also be produced during actively induced ignition, it is expedient if an ignition chamber is provided in which the ignition device is arranged and which is part of a fluid connection in which the fluid flow is guided; the fluid flow is thus guided through the ignition chamber. This ignition chamber can, for example, be designed to be spherical in order to withstand the highest possible pressures. In addition, this ignition chamber can be designed as small as possible in order to have only a small gas space and short burn-off times.

Preferably, the fluid connection, in the flow direction, after the ignition chamber, in particular immediately after the ignition chamber, has a siphon- or U-shaped course. In particular, the siphon- or U-shaped course of the fluid connection is designed in such a way that, in the direction of flow, first an at least substantially vertically downward (i.e., in the direction of gravity) and then an at least substantially vertically upward (i.e., against the direction of gravity) section are provided. Such a course of the fluid line, e.g., in the form of a correspondingly shaped tube, ensures that an explosion front that occurs does not propagate further downstream, but is prevented from further propagation by the siphon- or U-shaped course.

The section running vertically downwards and/or the section running vertically upwards should have at least a certain length. The diameter as well as the interior, and possibly also a length of the vertically running sections, should in particular be designed in such a way that e.g., a so-called “bubble flow,”, a so-called “slugflow,” or a so-called “churnflow” (tilting flow or foam flow) can be maintained, in which gas bubbles are contained in liquid. An “annular flow” (ring flow or film flow) or “mist flow” (fog flow), on the other hand, should be avoided through suitable design or shaping.

In particular, a flow pattern is desired in which the gas phase is safely interrupted by a liquid phase, which is not the case with “annular flow” (ring flow or film flow) and “mist flow” (fog flow), which should therefore be excluded as far as possible by the design. It should be mentioned that the siphon- or U-shaped course of the fluid connection are one way of achieving the desired flow shape, but other shapes and courses of the fluid connection are also possible, since it is in particular the interruption of the gas phase by the liquid phase that is important.

Curved sections of the siphon or U-shaped course should be shaped correspondingly to prevent reflections of the pressure waves, i.e., for example in accordance with TRGS 407 they should have at least 5 L/D (L/D stands for a ratio of length to diameter).

This purposefully induced ignition and, in particular, the specially designed ignition chamber mean that the other lines can be designed for significantly lower pressure than before, resulting in significant cost savings. This is particularly advantageous in that it also allows plastic, e.g., fiber-reinforced plastic, to be used in large parts of the lines, so that the use of metal lines and the associated higher degradation rates in the PEM are avoided. The use of plastic for lines would generally not be possible at, for example, 3.5 barg operating pressure in the fluid line or a line for discharged oxygen, at least for larger diameters, as these would then not withstand at least 25 times the pressure. Upstream compression of the gas flow to remove any remaining hydrogen would not have been possible up to now, as the compressors required for this would as a rule also not be able to withstand these pressures.

Although the invention is described primarily with respect to PEM electrolysis, it should be noted that the invention is suitable for all water electrolyses in which there is the risk of an ignitable mixture of hydrogen and oxygen.

The invention is explained in more detail below with reference to the accompanying drawing, which shows a system according to a preferred embodiment of the present invention.

### BRIEF DESCRIPTION OF THE DRAWINGS

FIG. 1 schematically shows an electrolysis system according to the invention in a preferred embodiment.

FIG. 2 schematically shows a part of the electrolysis system of FIG. 1.

FIG. 3 schematically shows different types of flow.

### DETAILED DESCRIPTION OF THE DRAWINGS

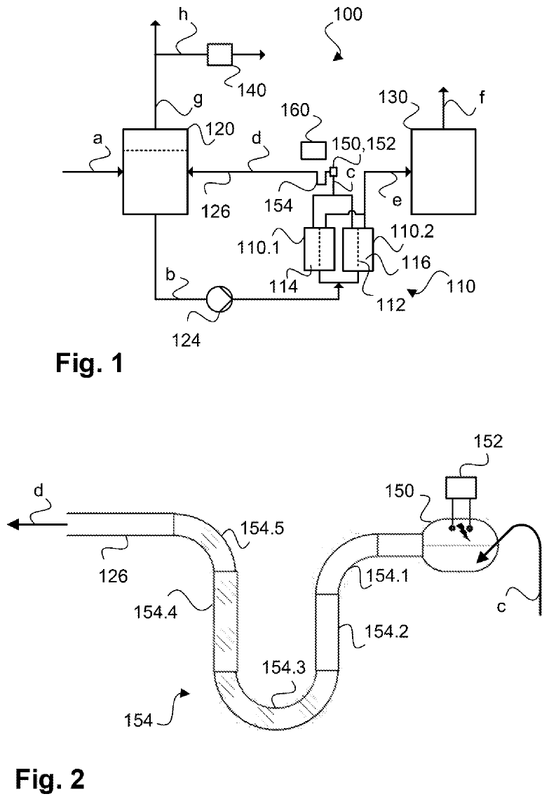

FIG. 1 schematically shows an electrolysis system 100 according to the invention in a preferred embodiment, in which a method according to the invention can also be carried out. By way of example, this is an electrolysis system for water electrolysis using PEM. In particular, the electrolysis system shown here and generally described within the scope of the invention is an electrolysis system on an industrial scale, for example to obtain hydrogen on an industrial scale. A typical power of such an electrolysis system is, for example, more than 10 MW or even more than 20 MW.

The electrolysis system 100 has an electrolysis unit 110, which here has, as an example, two so-called electrolysis cells or stacks 110.1, 110.2, in each of which a proton exchange membrane (PEM) 112 is provided. The PEM 112 separates each of the electrolysis cells into an oxygen side 114 and a hydrogen side 116. The oxygen sides 114 and the hydrogen sides 116 can be regarded together as the oxygen side and the hydrogen side, respectively, of the electrolysis unit 110. It should be noted that an electrolysis unit 110 may also have, for example, only one electrolysis cell or more than two electrolysis cells, depending on its size and requirements.

The electrolysis system 100 further comprises a container 120 used as a gas separator, here in particular as an oxygen separator or oxygen-water separator. The container 120 is connected via a fluid connection to the electrolysis unit 110, or there to each of the electrolysis cells 110.1, 110.2. As a result, a fluid flow b can be pumped from the container 120 to the electrolysis unit, for example by a pump 124. The electrolysis unit 110 is also connected to the container 120 via a fluid connection 126, e.g., pipes. Through the fluid connection 126, a fluid flow c can be pumped from the electrolysis unit 110, there the oxygen side 114 or the oxygen side of each electrolysis cell, to the container 120; the pump 124 is also sufficient for this purpose.

Furthermore, the electrolysis system 100 has another gas separator 130, here a hydrogen separator or hydrogen-water separator.

Although only one electrolysis unit 110 is shown here, more than one of them may be provided, for example depending on the size and power of the electrolysis system 100. Several electrolysis units can then, for example, nonetheless be connected to a common container for gas or oxygen separation and/or to a common hydrogen separator.

During operation of the electrolysis system 100, the fluid flow b, which includes water, is now pumped from the container 120 to the electrolysis unit 110. There the water is converted into oxygen and hydrogen. For this purpose, an electrical voltage is applied to the electrolysis unit 110, the hydrogen is electrochemically transported through the PEM 112 to the hydrogen side 116 and can be fed from there, possibly still mixed with water vapor and a liquid water phase, as flow e to the hydrogen separator 130. There, the hydrogen can be deposited and discharged or stored as flow f for further use, for example. The separated water is supplied, for example, to a treatment and then returned to the main water circuit.

The oxygen remains on the oxygen side along with most of the water 114. As mentioned, however, hydrogen may also be present in some quantity on the oxygen side 114. The resulting fluid flow c thus has water and gas, in particular water, oxygen and hydrogen. The fluid flow c is now guided through an ignition chamber 150 in which an ignition device 152 is provided. Further, the fluid flow is guided through a siphon- or U-shaped course 154 of the fluid connection 126 and then reaches the container or the gas separator 120 as fluid flow d. Thus, a total fluid flow is circulated between the container 120 and the electrolysis unit 110.

As mentioned, gas, in particular oxygen (and any hydrogen that may still be present), is separated from the water in container 120; the gas separated in this process as well as can be discharged or stored as flow g, for example for further use. Also conceivable is a further branching off as flow h to a purification, for example in order to remove any hydrogen still present and to dry the gas, or to a compressor.

Since water is converted into oxygen and hydrogen in the electrolysis unit 110 and the oxygen and hydrogen are discharged, the amount of water is reduced and therefore—in order to maintain continuous operation—new water (so-called make-up water) can be supplied from an external source as flow a.

This water a can be treated beforehand, for example, but this is not further relevant for the present invention. Similarly, if necessary, water separated in the hydrogen separator 130 can be returned to the container 120, possibly also after prior treatment.

In the ignition chamber 150, an ignition of an ignition device 152 (i.e., an ignition source) is now produced, for example with a specific frequency, in order to ignite an ignitable gas mixture of hydrogen and oxygen that may be present in the fluid flow c. Due to the siphon- or U-shaped course 154 and the flow regime that is established there, the resulting pressure wave does not propagate further downstream; the resulting fluid flow d thus certainly has a hydrogen content below the lower ignition limit, either because there was only a small amount of hydrogen (below the lower ignition limit) in the material flow c or because, at a higher concentration, the ignition has already occurred in the ignition chamber 150.

Furthermore, a control unit 160 is shown by way of example, by means of which, for example, the ignition device 152 can be controlled and, if necessary, also monitored.

FIG. 2 schematically shows a portion of the electrolysis system of FIG. 1 in more detail, namely the fluid connection 126 from the ignition chamber 150 to after the siphon- or U-shaped course 154. Fluid flow c, coming from the oxygen side of the electrolysis unit, enters the ignition chamber 150 and fluid flow d, which is led to the gas separator, exits at the end. As already mentioned, the ignition chamber can be arranged as close as possible to the electrolysis unit. A region of high design pressures can thus be kept small. In addition, an arrangement of the ignition chamber above the electrolysis unit (seen in the direction of gravity) is particularly expedient in order to keep the electrolysis unit safely covered with water. An integration of the fluid flow c into the ignition chamber 150 should take place in particular from above to below the liquid level, as indicated in FIG. 2.

The ignition chamber 150 is, as an example, made approximately spherical here and the ignition device 152 comprises, as an example, two electrical contacts which extend into the interior of the ignition chamber. By applying an electrical voltage to these contacts, an ignition can be actively induced or produced in the ignition chamber 150. The ignition is indicated by way of example as a lightning symbol.

By way of example, the fluid connection 126, in the direction of flow, downstream of the ignition chamber 150 has a siphon- or U-shaped course 154. Here, the fluid connection 126—which can basically be a pipe or the like—briefly runs horizontally, then has an arcuate section 154.1 (with a bend of about 90°) and thus goes over into a section 154.2 that runs vertically downward. Then the section 154.2 goes with an arcuate section 154.3 (with about 180° bend) into a vertically upward-running section 154.4. Then the section 154.4 with an arcuate section 154.5 (with a bend of about 90°) goes over again into a horizontally running section; this can then continue to run horizontally, e.g., up to the container.

Here, the siphon- or U-shaped course of the fluid connection is designed in such a way that, in the direction of flow, first an at least substantially vertically downward (i.e., in the direction of gravity) and then an at least substantially vertically upward (i.e., against the direction of gravity) section are provided. Such a course of the fluid line, e.g., in the form of a correspondingly shaped tube, ensures that an explosion front that occurs does not propagate further downstream, but is prevented from further propagation by the siphon- or U-shaped course.

As mentioned, the ignition in the ignition chamber 150 causes any ignitable mixture present to explode, the pressure wave of which, however, due to the siphon- or U-shaped course, only propagates to, at most, approximately the end (in the direction of flow) of the section 154.4. In this respect, the fluid connection 126 further downstream—and likewise the container 120 and any further gas connections (e.g., for flows g and h)—need not be designed to be explosion- or detonation-resistant. Rather, it is sufficient if the ignition chamber 150, the fluid connection 126 up to and including the section 154.4 (or somewhat further if necessary) and upstream of the ignition chamber 150 are designed to be explosion- and detonation-resistant.

As already mentioned, the siphon- or U-shaped course 154, in particular with regard to the diameter and lengths of the individual sections, should be designed in such a way that no “annular flow” (ring flow or film flow) and no “mist flow” (fog flow) occur.

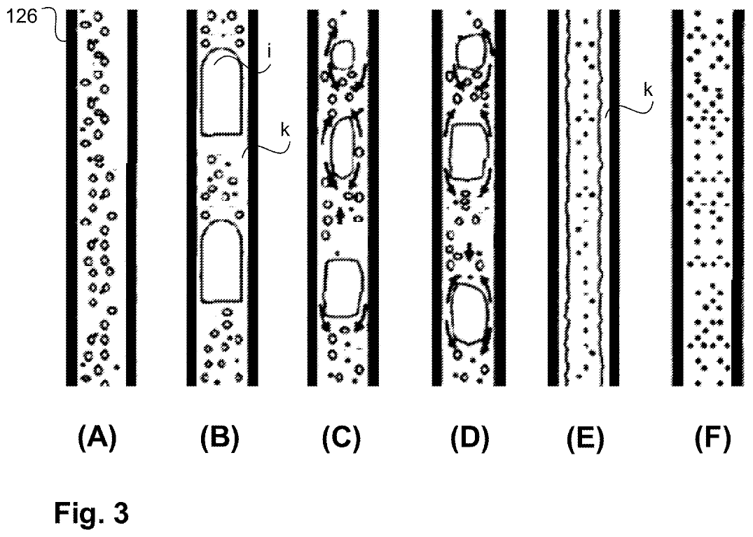

For this purpose, various flow types are shown in FIG. 3. In each of the views (A) to (F), a part of the fluid connection 126 is shown, in particular in the region of the siphon- or U-shaped course 154, there in turn in particular where light hatching is shown in the interior in FIG. 2. Here gas bubbles are designated by i, while liquid is designated by k.

View (A) illustrates a so-called “bubble flow” in which medium-sized gas bubbles are distributed in the liquid. View (B) illustrates a so-called “slug flow,” and views (C) and (D) each illustrate a so-called “churn flow,” but in different ways. These three or four types of flow are permitted or desired in order to safely interrupt the gas phase between the ignition chamber 150 and the fluid connection 126 and to prevent propagation of the pressure wave in the downstream direction.

View (E) illustrates a so-called “annular flow” (ring flow or film flow), in which pure liquid collects at the wall of the fluid connection (or pipe), while further inside there is a fine mixture of gas and liquid. View (F) illustrates a so-called “mist flow” in which a fine mixture of gas and liquid occurs throughout. Both of these types of flow are to be prevented by suitably shaping the siphon- or U-shaped course 154. A flow shape can be influenced by the flow speed, i.e., in particular by the diameter of the pipeline, in particular in the vertically rising part.

What is claimed is:

1. A method for operating an electrolysis system, in which water is converted into oxygen and hydrogen in an electrolysis unit,
wherein a fluid flow comprising water and gas is conducted from an oxygen side of the electrolysis unit to a gas separator,
wherein an ignition of an ignition device is actively produced in the fluid flow.

2. The method according to claim 1, wherein the ignition is produced at regular or irregular time intervals, in particular with a predetermined frequency.

3. The method according to claim 1, wherein it is monitored whether the ignition is produced, and wherein in particular if it is detected that the ignition is not produced, a fault response is initiated.

4. The method according to claim 1, wherein in the fluid flow between the ignition device and the gas separator a gas phase is interrupted by a liquid phase, in particular by means of an adaptation of a flow shape of a two-phase flow.

5. An electrolysis system comprising an electrolysis unit in which water can be converted into oxygen and hydrogen, a gas separator, and a fluid connection via which an oxygen side of the electrolysis unit is connected to the gas separator,
wherein the electrolysis system is set up to produce, in the fluid connection, from the oxygen side of the electrolysis unit to the gas separator a fluid flow, wherein the fluid flow comprises water and gas,
wherein the electrolysis system has an ignition device in the fluid connection and is set up to actively produce an ignition of the ignition device in the fluid connection.

6. The electrolysis system according to claim 5, having an ignition chamber as part of the fluid connection, wherein the ignition device is arranged in the ignition chamber.

7. The electrolysis system according to claim 6, wherein the fluid connection, in the flow direction, after the ignition chamber, in particular immediately after the ignition chamber, has a siphon- or U-shaped course.

8. The electrolysis system according to claim 7, wherein the siphon- or U-shaped course of the fluid connection is designed in such a way that, in the direction of flow, first an at least substantially vertically downward and then an at least substantially vertically upward running section are provided.

9. The electrolysis system according to claim 6, wherein the ignition chamber is arranged above the electrolysis unit and/or, in the flow direction, immediately downstream of the electrolysis unit.

10. The electrolysis system according to claim 5, set up to carry out a method fro operating an electrolysis system, in which water is converted into oxygen and hydrogen in an electrolysis unit,
wherein a fluid flow comprising water and gas is conducted from an oxygen side of the electrolysis unit to a gas separator,
wherein an ignition of an ignition device is actively produced in the fluid flow.
